(19) United States
(12) Patent Application Publication
(10) Pub. No.: US 2016/0252908 A1
(43) Pub. Date: Sep. 1, 2016

(54) RECONFIGURABLE DRIFT MEASUREMENT TOOL

(71) Applicant: Ocean Lab, LLC, Glendale, CA (US)

(72) Inventor: Tyler MacCready, Pasadena, CA (US)

(21) Appl. No.: 14/792,359

(22) Filed: Jul. 6, 2015

Related U.S. Application Data
(60) Provisional application No. 62/126,114, filed on Feb. 27, 2015.

(51) Int. Cl. G05D 1/02; G08G 3/00; G05D 1/00

(52) U.S. Cl. CPC G05D 1/0206; G05D 1/0027; G08G 3/00

(57) ABSTRACT

A system and method for characterizing fluid flow. A plurality of craft is deployed on the surface of the fluid, each of the craft configured to operate in either a fluid-transiting state or a fluid-tracking state. The craft are further configured, when a spatial arrangement of the craft satisfies a first condition, to execute a regrouping maneuver. The execution of the regrouping maneuver includes a first craft of the plurality of craft transitioning from the fluid-tracking state to the fluid-transiting state; the first craft changing its position; and the first craft transitioning from the fluid-transiting state to the fluid-tracking state.

### CROSS-REFERENCE TO RELATED APPLICATION(S)

The present application claims priority to and the benefit of U.S. Provisional Application No. 62/126,114, filed Feb. 27, 2015, entitled “RECONFIGURABLE DRIFT MEASUREMENT TOOL”, the entire content of which is incorporated herein by reference.

### FIELD

One or more aspects of embodiments according to the present invention relate to fluid flow characterization, and more particularly to a system and method for measuring fluid flow velocity at a plurality of points in the fluid.

### BACKGROUND

Investigations of fluid flow may be helpful for characterizing and understanding a range of phenomena. For example, the surface fluid flow velocity in a body of water may provide information on currents flowing parallel to the surface, and, to the extent the surface flow diverges or converges, it may provide information on upwelling or downwelling currents.

Surface flow velocity data may be used as input data for, or to confirm the predictions of, three-dimensional models of the fluid, such as numerical models simulating temperature, flow velocity, and salinity of an ocean. Such models may be constructed at a certain (e.g., 10 m) resolution, and it may be advantageous for the surface flow velocity data to be obtained at a similar (e.g., 10 m) resolution.

Surface fluid flow may be characterized by measuring the positions or velocities of floating objects, or “drifters.” Such objects, however, may move over time so that they are unevenly distributed, or otherwise positioned in a manner that prevents collection of data at a desired resolution. Thus, there is a need for a system and method for repositioning a collection of drifters.

### SUMMARY

Aspects of embodiments of the present disclosure are directed toward a system and method for characterizing fluid flow. A plurality of craft, or “drifters” is deployed on the surface of the fluid. Each drifter is capable of operating in either a fluid-tracking state or a fluid-transiting state, and of switching between the states. Each drifter is equipped with a radio, a global positioning system (GPS) sensor, a propulsion motor and a steering actuator. In the fluid-transiting state, the drifter is capable of maneuvering to a new position. Various methods are employed to restore the arrangement of the drifters to one suitable for gathering drift data when accumulated drift motion has caused the drifters to move into an arrangement in which data collection is impaired.

According to an embodiment of the present invention there is provided a system for characterizing fluid flow, the system including: a plurality of craft, each craft of the plurality of craft being configured to operate in either a fluid-transiting state or a fluid-tracking state; the craft being configured, when a spatial arrangement of the craft satisfies a first condition, to execute a regrouping maneuver, the execution of the regrouping maneuver including: a first craft of the plurality of craft transitioning from the fluid-tracking state to the fluid-transiting state; the first craft moving to a different position; and the first craft transitioning from the fluid-transiting state to the fluid-tracking state.

In one embodiment, the first condition is satisfied when a separation between a second craft of the plurality of craft and a third craft of the plurality of craft is greater than a set distance.

In one embodiment, the third craft is the nearest craft, of the plurality of craft, to the second craft.

In one embodiment, the third craft is the most distant craft, of the plurality of craft, from the second craft.

In one embodiment, the first condition is satisfied when a separation between a second craft of the plurality of craft and a third craft of the plurality of craft is less than a set distance.

In one embodiment, the third craft is the nearest craft, of the plurality of craft, to the second craft.

In one embodiment, the execution of the regrouping maneuver further includes the first craft moving to a position within a threshold distance of a set geographic location.

In one embodiment, the threshold distance is 3 meters.

In one embodiment, the execution of the regrouping maneuver further includes the first craft moving to within a threshold distance of a set position relative to a center of the plurality of craft.

In one embodiment, the center of the plurality of craft is the centroid of the plurality of craft.

In one embodiment, the execution of the regrouping maneuver further includes the first craft moving to within a threshold distance of a set position relative to a second craft of the plurality of craft.

In one embodiment, the execution of the regrouping maneuver further includes the second craft remaining in the fluid-tracking state during the regrouping maneuver.

In one embodiment, the first condition is satisfied when the distance between the first craft and a center of the plurality of craft exceeds a threshold distance.

In one embodiment, the execution of the regrouping maneuver further includes the first craft moving to a location nearer the center of the plurality of craft than the threshold distance.

In one embodiment, each of the plurality of craft includes a processor and a radio connected to the processor, and the system further includes a maneuver controller configured to: receive position information from each of the plurality of craft; assess whether the first condition has been satisfied; and command each of the plurality of craft to execute the regrouping maneuver when the first condition is satisfied.

In one embodiment, the maneuver controller includes: a processor; a display; a user input device; and a radio configured to exchange data with each of the plurality of craft.

According to an embodiment of the present invention there is provided a method for controlling a system for characterizing fluid flow, the system including a plurality of craft, the method including: when a spatial arrangement of the craft satisfies a first condition, executing a regrouping maneuver including: transitioning, by a first craft of the plurality of craft, from a fluid-tracking state to a fluid-transiting state; moving, by the first craft, to a different position; and transitioning, by the first craft, from the fluid-transiting state to the fluid-tracking state.

In one embodiment, the first condition is satisfied when a separation between a second craft of the plurality of craft and a third craft of the plurality of craft is greater than a set distance.

In one embodiment, the first condition is satisfied when a separation between a second craft of the plurality of craft and a third craft of the plurality of craft is less than a set distance.

In one embodiment, the regrouping maneuver further includes moving, by the first craft, to within a threshold distance of a set geographic location.

### BRIEF DESCRIPTION OF THE DRAWINGS

These and other features and advantages of the present invention will be appreciated and understood with reference to the specification, claims and appended drawings wherein:

FIG. 1A is a schematic side view of a drifter, according to an embodiment of the present invention;

FIG. 1B is a schematic top view of a drifter in a low-drag, fluid-transiting state, according to an embodiment of the present invention;

FIG. 1C is a schematic top view of a drifter in a high-drag, fluid-tracking state, according to an embodiment of the present invention;

FIG. 2 is a schematic diagram of a central controller and an arrangement of drifters, according to an embodiment of the present invention;

FIG. 3A is a diagram of a reference frame, according to an embodiment of the present invention;

FIG. 3B is a diagram of a voracity measurement, according to an embodiment of the present invention;

FIG. 3C is a diagram of a divergence measurement, according to an embodiment of the present invention;

FIG. 3D is a diagram of an arrangement of drifters configured for measurements on several length scales, according to an embodiment of the present invention;

FIG. 4A is a diagram of an arrangement of drifters configured for obtaining velocity data, according to an embodiment of the present invention;

FIG. 4B is a diagram of the drifters of FIG. 4A after time has elapsed and the drifters have moved into an arrangement in which data taking is impaired, according to an embodiment of the present invention;

FIG. 4C is a diagram of the drifters of FIG. 4B, again configured for obtaining velocity data after the execution of a regrouping maneuver, according to an embodiment of the present invention;

FIG. 5A is a diagram of an arrangement of drifters configured for obtaining velocity data, according to another embodiment of the present invention;

FIG. 5B is a diagram of the drifters of FIG. 5A after time has elapsed and the drifters have moved into an arrangement in which data taking is impaired, according to an embodiment of the present invention;

FIG. 5C is a diagram of the drifters of FIG. 5B, again configured for obtaining velocity data after the execution of a regrouping maneuver, according to an embodiment of the present invention;

FIG. 6A is a diagram of an arrangement of drifters configured for obtaining velocity data, according to yet another embodiment of the present invention;

FIG. 6B is a diagram of the drifters of FIG. 6A after time has elapsed and the drifters have moved into an arrangement in which data taking is impaired, according to an embodiment of the present invention;

FIG. 6C is a diagram of the drifters of FIG. 6B, again configured for obtaining velocity data after the execution of a regrouping maneuver, according to an embodiment of the present invention; and

FIG. 7 is a diagram of an arrangement of drifters, according to an embodiment of the present invention, within a circle, each drifter being configured to navigate to the center of the circle if it drifts outside of the circle.

### DETAILED DESCRIPTION

The detailed description set forth below in connection with the appended drawings is intended as a description of exemplary embodiments of a reconfigurable drift measurement tool provided in accordance with the present invention and is not intended to represent the only forms in which the present invention may be constructed or utilized. The description sets forth the features of the present invention in connection with the illustrated embodiments. It is to be understood, however, that the same or equivalent functions and structures may be accomplished by different embodiments that are also intended to be encompassed within the spirit and scope of the invention. As denoted elsewhere herein, like element numbers are intended to indicate like elements or features.

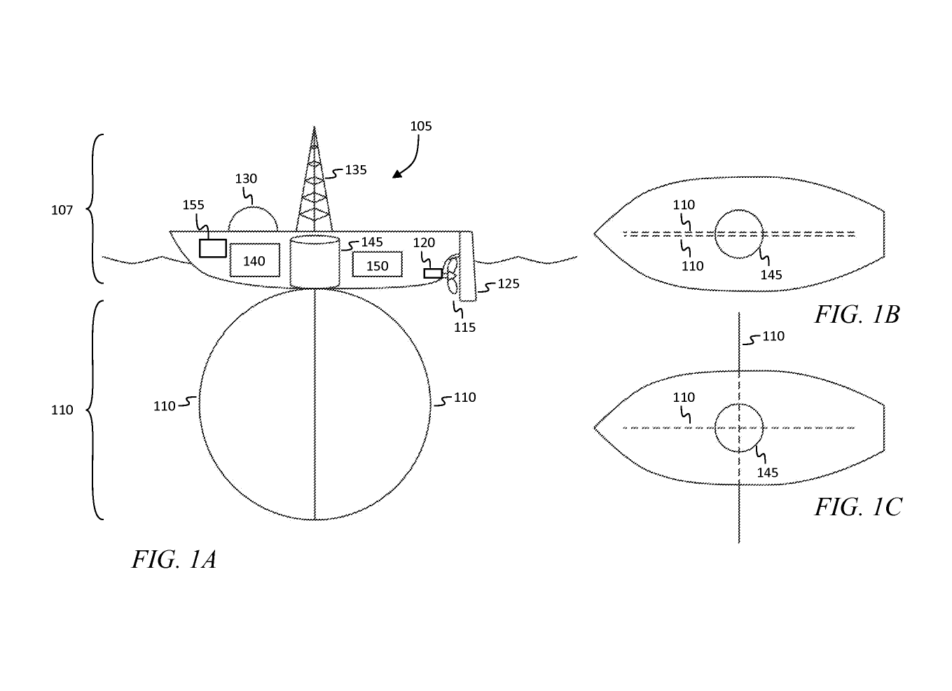

Referring to FIG. 1A, in one embodiment a drifter 105 for measuring surface velocity in a body of water is a craft including a buoyant element 107 for keeping the craft at the surface and one or more vanes or “fins” 110. One or more of the fins 110 may be articulated, allowing the configuration of fins 110 to assume a low-drag state (FIG. 1B) in which the fins 110 are substantially parallel or a high-drag state in which the fins 110 are not parallel, e.g., the fins 110 may be perpendicular as shown in FIG. 1C. When the fins 110 are in the high-drag state, the velocity of the drifter 105 relative to the water may be small, even in the presence of external forces such as wind, because of the high drag provided by the fins 110. In this state the drifter 105 therefore tracks the water, i.e., it moves with a velocity substantially equal to the surface velocity of the water.

Thus, the high-drag state is one example of a fluid-tracking state. As used herein, a fluid-tracking state is a state in which the drifter 105 is configured to move with a fluid (e.g., with the water). Similarly, as used herein, a fluid-transiting state is a state in which the drifter 105 is configured to move relative to the fluid, and the low-drag state is an example of a fluid-transiting state. A transition from the fluid-transiting state to the fluid-tracking state may involve changing the relative orientation of fins, as described above, or it may involve, by way of non-limiting examples, a change in attitude of the entire drifter 105, a change in buoyancy of the drifter 105 (and a corresponding change in the position of the drifter with respect to the fluid surface), a change in propulsion of the drifter 105 (such as the energizing of a propulsion system), or a combination of such changes.

When the fins 110 are in the fluid-transiting state, i.e., when the fins 110 are substantially parallel to each other, the resistance to motion through the water of the drifter 105, in a direction parallel to the fins 110, may be relatively small. In this state, the drifter 105 may be capable of moving through the water, propelled for example by a propeller 115 driven by a propulsion motor 120 and steered by a rudder 125. The drifter 105 may be equipped with a sensing unit 130 including a compass and global positioning system (GPS) receiver, a radio 135 for communicating with other drifters 105 or a with a central controller 210, an autopilot 140 for receiving sensor data and generating propulsion and steering commands, a fin actuation motor 145 for rotating the articulated fin or fins 110, and a battery 150 for powering the propulsion motor 120, the rudder 125, the sensing unit 130, the radio 135, the autopilot 140, and the fin actuation motor 145. The drifter 105 may include a processor for coordinating the flow of data between the radio 135, the sensing unit 130, and the actuators (e.g., the propulsion motor 120 and the rudder 125). The processor may also execute the functions of the autopilot 140. Each drifter 105 may have a serial number or other unique numerical identifier; the value of this unique numerical identifier may be available to the processor and may be used, for example, for arbitration between drifters 105, as described in further detail below.

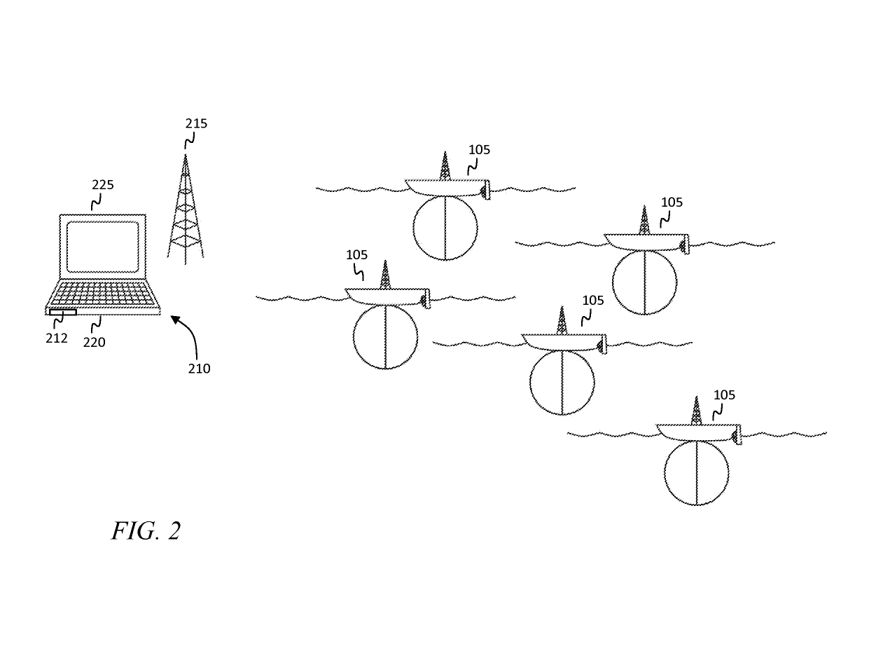

Referring to FIG. 2, in one embodiment, a central controller 210 has a user interface and a radio 215. The user interface may include a keyboard 220, a mouse, a display 225, and software for receiving user input and for generating graphics, such as user controls, or information displays for displaying data to a user in a readily comprehensible format. A multitude or “swarm” of drifters 105 is deployed in a body of water, in communication with the central controller 210. The drifters 105 may also be in communication with each other. The central controller 210 may receive streaming real-time position and heading data from each drifter 105, and it may execute one or more algorithms for recording data received from the drifters 105 and for commanding the drifters 105, e.g., to change position as needed. The central controller 210 may also perform analysis of the received data, to generate derived quantities, for storage or for display to the user via the user interface. The central controller 210 may be a laptop computer. Each drifter 105 may also be aware of the location of each other drifter 105, either as a result of direct communications between the drifters 105, which may inform each other of their respective positions (as determined by their GPS receivers), or, for example, as a result of the central controller 210 compiling and distributing (e.g., broadcasting) all of the drifters' locations periodically (e.g., once per second).

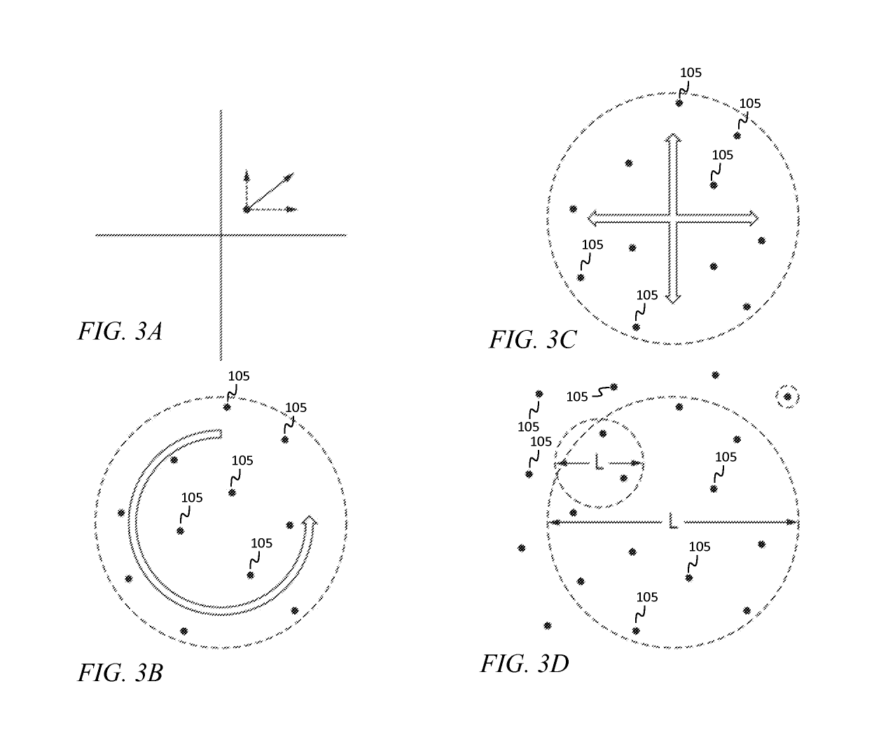

Referring to FIG. 3A, each drifter 105 may have a velocity with respect to a reference frame. The reference frame may be a geographic reference frame, and the position of each drifter 105 with respect to the reference frame may be measured by the GPS receiver of the drifter 105. The reference frame may include an x-axis and a y-axis, which may be parallel to the local parallel and the local meridian, respectively. The velocity of each drifter 105 may then have an x-component referred to as u, and a y-component referred to as v.

Referring to FIG. 3B, a quantity referred to as the group vorticity of a group of drifters 105 may be defined. This quantity may approximate the local surface vorticity, defined as

$$\frac{d v}{d x} - \frac{d u}{d y} ,$$

where

$$\frac{d v}{d x}$$

is the derivative of the y-component of the surface velocity with respect to position coordinate x, and

$$\frac{d u}{d y}$$

is the derivative of the x-component of the surface velocity with respect to position coordinate y. The group vorticity may be defined and calculated, for example, as follows. First, a least-squares fit of a straight line to the set of points (xᵢ,vᵢ), is performed, where xᵢ is the x-coordinate of the position of the i^{th} drifter and vᵢ is the y-component of the velocity of i^{th} drifter. The slope m₁ of this first line is an estimate of the derivative

$$\frac{d v}{d x} .$$

Second, a least-squares fit of a straight line to the set of points (yᵢ,uᵢ) is performed, where yᵢ is the y-coordinate of the position of the i^{th} drifter and uᵢ is the x-component of the velocity of i^{th} drifter. The slope m₂ of this second line is an estimate of the derivative

$$\frac{d u}{d y} .$$

Finally the group vorticity is calculated as the difference m₁−m₂.

Referring to FIG. 3C, the local divergence of the surface velocity may be defined as

$$\frac{d u}{d x} + \frac{d v}{d y} ,$$

where

$$\frac{d u}{d x}$$

is the derivative of the x-component of the surface velocity with respect to position coordinate x, and

$$\frac{d v}{d y}$$

is the derivative of the y-component of the surface velocity with respect to position coordinate y. In a manner analogous to the definition and calculation of the group vorticity, the group divergence may be defined and calculated by finding the slope m₁ of a first line that is a least-squares fit to the set of points (xᵢ,uᵢ) finding the slope m₂ of a second line that is a least-squares fit to the set of points (yᵢ,vᵢ), and calculating the group divergence as the sum m₁+m₂.

Referring to FIG. 3D, a sufficiently large group of drifters 105 may be able to measure phenomena such as vorticity simultaneously over a range of length scales. For example, a swarm of drifters 105 spaced 1 m apart and covering a roughly circular area with a diameter of 100 m may be able to measure vorticity on a length scale of 1 m, i.e., the smallest distance between a pair of drifters 105 in the swarm, on a length scale of 100 m, i.e., the largest distance between a pair of drifters 105 in the swarm, and on various intermediate length scales. This capability may be put to use, for example, in characterizing a fluid undergoing a process in which eddies of one length scale evolve to form eddies of a smaller length scale, for a range of length scales, resulting in a relationship, for a range of length scales, between the length scale and the vorticity at that length scale. This relationship may be measured using a swarm of drifters 105, and analyzed to determine, for example, whether it follows a power law expected for turbulence in a fluid. A deviation from such a power law relationship may indicate that phenomena other than turbulence are influencing the fluid flow. In FIG. 3, several length scales over which the illustrated spatial arrangement of drifters may measure vorticity are shows as dashed circles. A single drifter may also measure vorticity as its own rate of rotation, as illustrated by the dashed circle enclosing a single drifter.

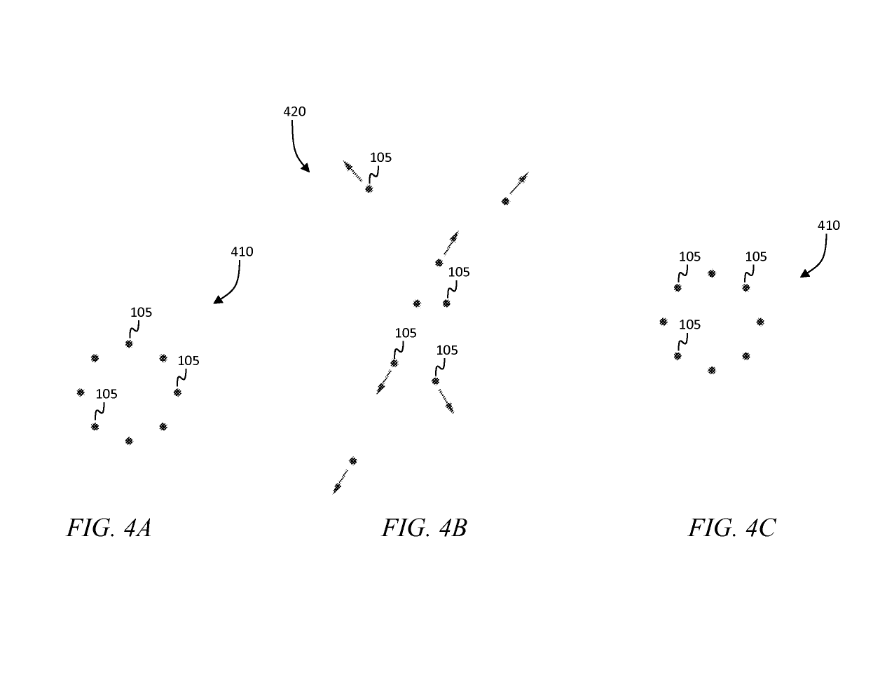

During a measurement interval, relative motion of the drifters 105 may cause the spatial arrangement of the drifters 105 to change, and the ability of the group of drifters 105 to capture useful data may degrade as a result. For example, if the drifters 105 are initially uniformly arranged within a 100 m diameter circle, and subsequently move so that they are more densely distributed within some parts of the circle and less densely distributed within other parts of the circle, then the minimum separation between drifters 105 in the latter parts of the circle may be too great to obtain, in those regions, surface velocity data at relatively small length scales. This degradation may be remedied by regrouping the drifters 105, i.e., executing a regrouping maneuver. Referring to FIGS. 4A-4C, in one embodiment, a “drive to shape” maneuver is used for regrouping. A first (or “nominal”) arrangement (or “shape” of the distribution of drifters 105) is defined; this may be an arrangement allowing surface velocity measurements to be made on certain length scales of importance. The drifters 105 may start in a nominal arrangement, which may be the first arrangement 410 (FIG. 4A), and, as time progresses, drift with the fluid until they are in a second arrangement 420 (FIG. 4B). They may then execute a “drive to shape” regrouping maneuver to return to the first arrangement 410 (FIG. 4C).

In one embodiment the first arrangement 410 is an absolute, e.g., geographic arrangement, and after the “drive to shape” regrouping maneuver (which, in this case, may be referred to as an absolute regrouping maneuver), the first arrangement is again formed, with the same shape and with drifters 105 at locations defined by the same absolute geographic locations. In another embodiment, the first arrangement 410 is defined to be a relative arrangement, i.e., the arrangement is defined by the coordinates of a plurality of nominal drifter 105 positions, relative to a reference point. In this case the “drive to shape” regrouping maneuver may result in the drifter 105 regrouping into the same shape, relative to a different geographic position. The reference point may be a “center” of the arrangement, which may be defined, for example, to be the centroid of the current drifter positions. For example, the first arrangement 410 may be a circle as shown in FIGS. 4A and 4C, and the “drive to shape” regrouping maneuver may result in the drifters 105 regrouping into a circle around the centroid of the positions of the drifters 105. This may be accomplished, for example, by calculating the centroid immediately before the regrouping maneuver is executed, and designating the centroid location as the absolute geographic position about which the circle is to be formed.

When the first arrangement 410 is a circle, the initial deformation of this arrangement may cause the arrangement to become an oval, corresponding for example to the circle stretching in one direction and contracting in a perpendicular direction. The ability to discern these characteristics of the surface velocity field may be lost or degraded, however, once the arrangement becomes sufficiently distorted; this ability may then be restored with a “drive to shape” regrouping maneuver.

In another embodiment, in the nominal arrangement the drifters 105 are evenly spaced on a square or rectangular grid, e.g., on a 1 m square grid, covering a 10 m by 10 m area, or a 100 m by 100 m area, for example. From such an arrangement, a divergence map, i.e., a map of upwelling and downwelling currents may be generated over the area covered by the drifters 105, with downwelling corresponding to areas in which the divergence is negative, i.e., in which the drifters 105 are approaching one another, and upwelling occurring in areas in which the divergence is positive, i.e., in which the drifters 105 are becoming more distant from one another. The ability of the system to update the divergence map may degrade with time, as the drifters 105 in regions of upwelling become widely separated, resulting in large regions in which no data are being obtained. In this case execution of a “drive to shape” regrouping maneuver may restore the ability of the system to obtain divergence information.

In one embodiment, a regrouping maneuver is automatically performed by the system when a set condition, or “trigger criterion” is met. Various trigger criteria may be used. For example, a regrouping maneuver may be triggered when the size of the arrangement exceeds a threshold, e.g., for a nominal arrangement in which drifters 105 are evenly spaced on a grid of 1 m squares, covering a 20 m by 20 m area, a regrouping maneuver may be triggered when the distance between any pair of drifters 105 exceeds 100 m. In another embodiment, if a uniform distribution of drifters 105 is to be maintained, the trigger criterion may be based on a statistical measure of the uniformity of the distribution. For example, a local density at any point may be defined as the number of drifters 105 within a circle of a set diameter, e.g., 50 m, centered on the point. A statistical characteristic such as the variance of the local density may then be used as a trigger criterion; for example, the trigger criterion may be satisfied when the variance of the local density exceeds a set threshold value. In other embodiments, a trigger criterion is satisfied when the separation between any drifter 105 and its nearest neighbor exceeds an upper threshold or falls below a lower threshold.

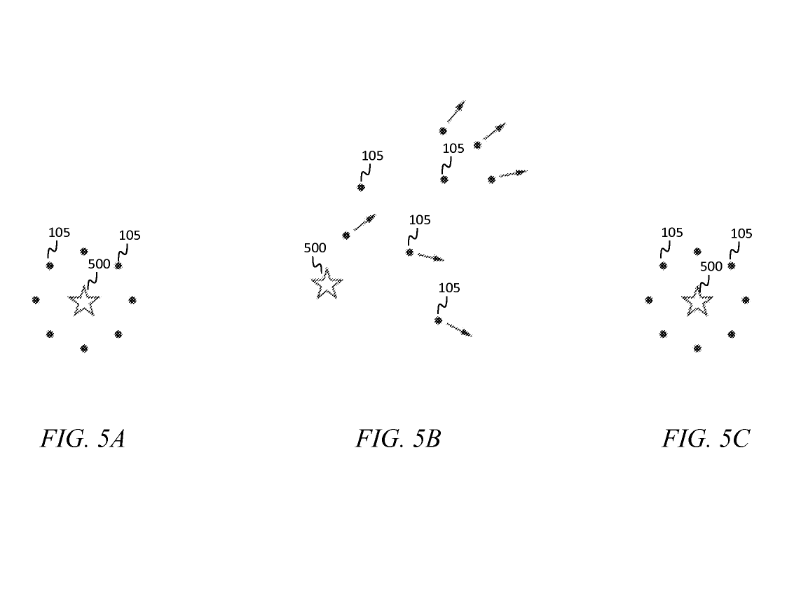

Referring to FIG. 5, in one embodiment a target is defined and regrouping maneuvers, referred to as “drive to shape around target” regrouping maneuvers, are executed relative to the target 500. In this embodiment, a “drive to shape around target” regrouping maneuver may result in each of the drifters 105 returning to a respective nominal position relative to the target. The target may be a fixed geographic location, or it may move. For example, the central controller 210 may be deployed on a boat and it may be the target. The “drive to shape around target” regrouping maneuver may be executed with the boat moving, e.g., drifting on the water, with the effect that the drifters 105 may be in an arrangement around the boat at the end of the regrouping maneuver.

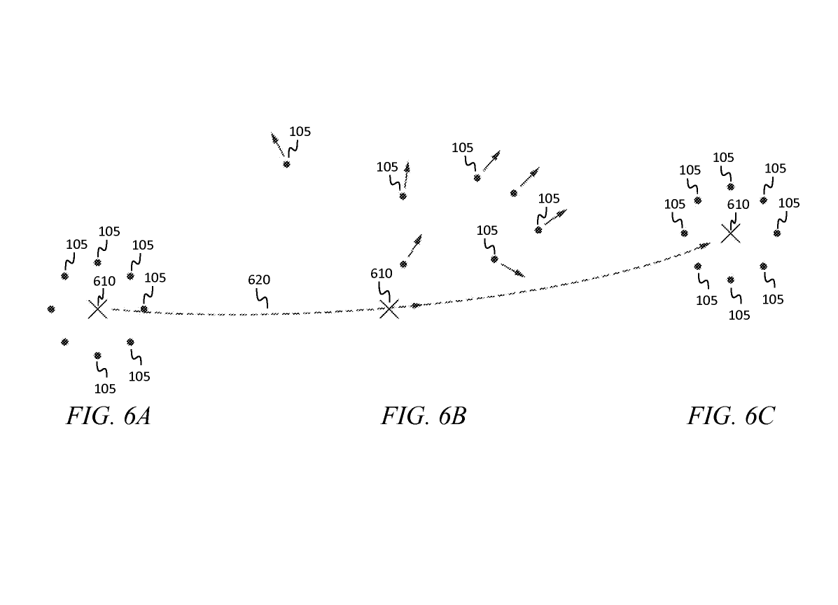

Referring to FIG. 6, in one embodiment one drifter 105 is designated as a central drifter 610, and it may be located at the center of a region of interest to be characterized. The central drifter, or “continuous drifter” 610 drifts along a path 620 following the flow of the fluid. The other drifters 105 begin in a nominal arrangement around the central drifter 610. Over time, they may drift away from the nominal arrangement, to a distorted arrangement in which data gathering may be impaired. A regrouping maneuver is performed and the other drifters 105 move back into a nominal position relative to the central drifter 610, which remains in the fluid-tracking state during the regrouping maneuver. The motion of the central drifter 610 may then measure the velocity of the center of the region of interest, and other drifters 105 arranged about the central drifter 610 may measure derivatives of the velocity with respect to position on the surface. In this embodiment the central drifter 610 may follow the motion of a volume of fluid (e.g., a 1 m cube of water), and continue to monitor the position and velocity of this volume of fluid over a first, relatively long time interval, while the other drifters 105 may monitor derivatives of the velocity with respect to position, over a sequence of shorter time intervals, with a regrouping maneuver at the end of each of the shorter time intervals restoring the shape of the arrangement.

Regrouping maneuvers may be initiated and executed under the control of an entity referred to herein as a maneuver controller, which may be the central controller 210. In one embodiment, the maneuver controller monitors the positions of all of the drifters 105, determines when a trigger criterion has been met, and commands each drifter 105 to a new position. During an absolute regrouping maneuver, the maneuver controller may send a new absolute geographic position command to each drifter 105 at the beginning of the maneuver, and each drifter 105 may transition to the fluid-transiting state, navigate to the corresponding position, and hold that position. The maneuver controller monitors the progress of the drifters 105 toward their respective positions, and when each drifter 105 has reached its position, the maneuver controller commands all of the drifters 105 to transition to the fluid-tracking state, so that data taking can resume. A regrouping maneuver may proceed similarly in the case of a relative regrouping maneuver in which the target, e.g., a central drifter 610, continues to drift during the maneuver. In this case, the maneuver controller may send each drifter 105 a position command with coordinates corresponding to the current position of the central drifter 610, or corresponding to the extrapolated expected position of the central drifter 610 at the time the regrouping maneuver is expected to be completed. During the regrouping maneuver, the maneuver controller may send updated position commands to the drifters 105 as the central drifter 610 moves, or as it deviates from its predicted path. For example, if a first drifter's nominal position is 20 m directly north of the central drifter 610, then during the regrouping maneuver the maneuver controller may repeatedly send new position commands to the first drifter 105, each position command having geographic coordinates that are 20 m north of the current position of the central drifter 610.

During a regrouping maneuver it may not be necessary or practical for each drifter 105 to be precisely at its commanded position at the end the maneuver. When a drifter 105 is far (e.g., more than 10 m) from its commanded position, it may move toward its commanded position at a set cruising speed. When the drifter 105 approaches its commanded position (as determined by its GPS receiver), it may reduce the power provided to the propulsion motor, so that, for example, at close range the propulsion power is proportional to the position error. If wind or waves subsequently push the drifter 105 farther from its commanded position, it may again increase propulsion power and navigate back toward the commanded position. The maneuver controller, when assessing whether the regrouping maneuver has been completed (and the drifters 105 may be commanded to return to the fluid-tracking state), may check whether each drifter 105 is within a threshold radius, e.g., 5 m, of its commanded position, and consider the maneuver complete when this is the case. In another embodiment the maneuver controller deems the maneuver complete when each drifter 105 (i) has been, since the initiation of the regrouping maneuver, within a first threshold radius (e.g., 3 m) of its commanded position, and (ii) is currently within a second threshold radius (e.g., 5 m) of its commanded position.

In one embodiment, the maneuver controller is one of the drifters 105 and regrouping maneuvers are executed under the control of the drifter 105, e.g., a particular drifter 105 designated as the maneuver controller.

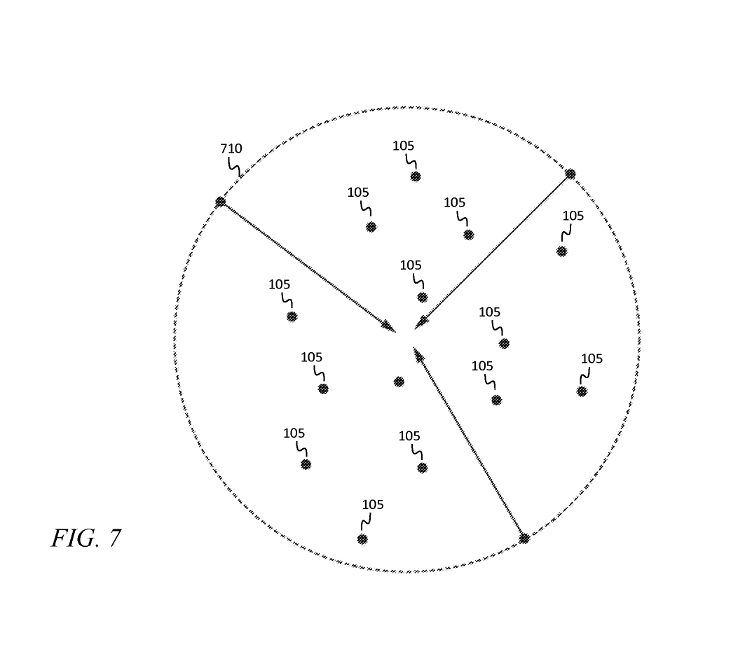

A regrouping maneuver may involve re-positioning all, or fewer than all, of the drifters 105 in the arrangement. For example, referring to FIG. 7, a trigger criterion may be defined to be satisfied when any drifter 105 moves outside of a circle 710 of a certain radius centered on a center of the arrangement (e.g., on the centroid of the arrangement), or centered on a fixed geographic location, or centered on one drifter 105, which may be referred to as a central drifter 610. In this case the regrouping maneuver may involve only the drifter 105 that is, or the drifters 105 that are, outside of the circle being re-positioned. If a single drifter 105 is outside of the circle 710 when the trigger criterion is satisfied, it may be commanded to return to the center of the arrangement (or to a location near the center, if returning to the center would risk a collision with another drifter 105). If several drifters 105 are outside of the circle when the trigger criterion is satisfied, each of them may be commanded to return to a respective position near the center of the arrangement, to avoid collisions. Collision avoidance may also be accomplished, in other situations, by other methods. For example, at the beginning of a regrouping maneuver the maneuver controller may calculate the projected path of each drifter 105 and, for each drifter 105, the minimum expected distance to any other drifter 105 during the maneuver, and if the minimum distance is sufficiently small to indicate a risk of collision between two drifters 105, the maneuver controller may command one or both of the affected drifters 105 to navigate, i.e., detour, to an intermediate waypoint before proceeding to the final commanded position. In another embodiment the maneuver controller may monitor the positions of the drifters 105 during the maneuver, and if two drifters 105 become sufficiently close to each other to indicate a risk of collision, the maneuver controller may command one or both of the drifters 105 to detour to avoid a collision.

In another embodiment, a trigger criterion may be used to implement collision avoidance, and collision avoidance regrouping maneuvers may be executed as needed during measurements, whenever two or more drifters 105 become sufficiently close that there is a risk of collision. Contact between drifters 105 may or may not carry a risk of damage to the drifters 105, but in any event contact may compromise the data collected, because when two drifters 105 are in contact their relative motion may be determined not primarily by the surface velocities at their respective positions but by forces they exert directly on each other. For example, a trigger criterion may be satisfied whenever the distance between any pair of drifters 105 is less than a threshold distance, e.g., 2 m. The regrouping maneuver may consist of each of the drifters 105 of the pair moving directly away from the other by a set distance, e.g., 10 m, or during some interval of time, e.g., 10 seconds. In other embodiments only one of the drifters 105, e.g., the one with a higher or lower serial number, moves away from the other, by a set distance, e.g., 10 m, or during a set interval of time, e.g., 10 seconds. In one embodiment, the maneuver controller for such a maneuver may be one or the other of the two drifters 105, e.g., the drifter 105 with the higher (or lower) serial number. In one embodiment collision avoidance methods may be supplemented by collision detection and reporting: when two drifters 105 are sufficiently close that they may be in contact, data generated by those drifters 105 may be discarded, or tagged as unreliable.

A regrouping maneuver may be characterized by an initial arrangement (e.g., the arrangement of the drifters 105 at the beginning of the regrouping maneuver) and a final arrangement; to these arrangements there correspond a set of initial locations for the drifters 105 and a set of final or “target” locations for the drifters 105. The final locations may be drifter-specific, e.g., each drifter 105 may have a geographic nominal position to which it returns during a regrouping maneuver. In another embodiment the final locations are not drifter-specific, and are treated by the maneuver controller as a set of target points, each of which should be occupied by one drifter 105 (but not necessarily a particular drifter 105) at the end of the regrouping maneuver. In this embodiment a method for assigning a drifter 105 to each location may involve iterating over all the drifters 105 and assigning to each the closest remaining target point to which a drifter 105 has not yet been assigned. In one embodiment the iteration is in order of distance from the center (e.g., the centroid) of the final arrangement, e.g., the drifter 105 that is most distant from the centroid is assigned a target location first, and the drifter 105 that is nearest the centroid is assigned a target location last.

A trigger criterion may be periodic, e.g., the maneuver controller may initiate a regrouping maneuver at regularly spaced points in time separated by a set time interval, e.g., every 10 minutes. The time interval may be chosen to be sufficiently short that the arrangement does not degrade to one in which the data-gathering capabilities of the arrangement are impaired to an unacceptable degree, and sufficiently long that the time consumed by the regrouping maneuvers does not significantly decrease the amount of useful data collected.

Although exemplary embodiments described herein relate to measurement of velocities on the surface of a fluid, the invention is not limited thereto. Drifters may be constructed (e.g., with buoyancy control) to move in three dimensions within a fluid, for example, and they may be employed in a variety of circumstances and a variety of fluids. Miniaturized drifters may be used, for example, to characterize fluid flows in artificial or natural enclosed fluid systems.

The term “processor” is used herein to include any combination of hardware, firmware, and software, employed to process data or digital signals. The hardware of a processor may include, for example, application specific integrated circuits (ASICs), general purpose or special purpose central processors (CPUs), digital signal processors (DSPs), graphics processors (GPUs), and programmable logic devices such as field programmable gate arrays (FPGAs). In a processor, as used herein, each function is performed either by hardware configured, i.e., hard-wired, to perform that function, or by more general purpose hardware, such as a CPU, configured to execute instructions stored in a non-transitory storage medium. A processor may be fabricated on a single printed wiring board (PWB) or distributed over several interconnected PWBs. A processor may contain other processors; for example a processor may include two processors, an FPGA and a CPU, interconnected on a PWB.

It will be understood that, although the terms “first”, “second”, “third”, etc., may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section, without departing from the spirit and scope of the inventive concept.

Spatially relative terms, such as “beneath”, “below”, “lower”, “under”, “above”, “upper” and the like, may be used herein for ease of description to describe one element or feature's relationship to another element(s) or feature(s) as illustrated in the figures. It will be understood that such spatially relative terms are intended to encompass different orientations of the device in use or in operation, in addition to the orientation depicted in the figures. For example, if the device in the figures is turned over, elements described as “below” or “beneath” or “under” other elements or features would then be oriented “above” the other elements or features. Thus, the example terms “below” and “under” can encompass both an orientation of above and below. The device may be otherwise oriented (e.g., rotated 90 degrees or at other orientations) and the spatially relative descriptors used herein should be interpreted accordingly. In addition, it will also be understood that when a layer is referred to as being “between” two layers, it can be the only layer between the two layers, or one or more intervening layers may also be present.

The terminology used herein is for the purpose of describing particular embodiments only and is not intended to be limiting of the inventive concept. As used herein, the terms “substantially,” “about,” and similar terms are used as terms of approximation and not as terms of degree, and are intended to account for the inherent deviations in measured or calculated values that would be recognized by those of ordinary skill in the art. As used herein, the term “major component” means a component constituting at least half, by weight, of a composition, and the term “major portion”, when applied to a plurality of items, means at least half of the items.

As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Expressions such as “at least one of,” when preceding a list of elements, modify the entire list of elements and do not modify the individual elements of the list. Further, the use of “may” when describing embodiments of the inventive concept refers to “one or more embodiments of the present invention”. Also, the term “exemplary” is intended to refer to an example or illustration. As used herein, the terms “use,” “using,” and “used” may be considered synonymous with the terms “utilize,” “utilizing,” and “utilized,” respectively.

It will be understood that when an element or layer is referred to as being “on”, “connected to”, “coupled to”, or “adjacent to” another element or layer, it may be directly on, connected to, coupled to, or adjacent to the other element or layer, or one or more intervening elements or layers may be present. In contrast, when an element or layer is referred to as being “directly on”, “directly connected to”, “directly coupled to”, or “immediately adjacent to” another element or layer, there are no intervening elements or layers present.

Any numerical range recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein and any minimum numerical limitation recited in this specification is intended to include all higher numerical limitations subsumed therein.

Although exemplary embodiments of a reconfigurable drift measurement tool have been specifically described and illustrated herein, many modifications and variations will be apparent to those skilled in the art. Accordingly, it is to be understood that a reconfigurable drift measurement tool constructed according to principles of this invention may be embodied other than as specifically described herein. The invention is also defined in the following claims, and equivalents thereof.

What is claimed is:

1. A system for characterizing fluid flow, the system comprising:
a plurality of craft,
each craft of the plurality of craft being configured to operate in either a fluid-transiting state or a fluid-tracking state;
the craft being configured, when a spatial arrangement of the craft satisfies a first condition, to execute a regrouping maneuver,
the execution of the regrouping maneuver comprising:
a first craft of the plurality of craft transitioning from the fluid-tracking state to the fluid-transiting state;
the first craft moving to a different position; and
the first craft transitioning from the fluid-transiting state to the fluid-tracking state.

2. The system of claim 1, wherein the first condition is satisfied when a separation between a second craft of the plurality of craft and a third craft of the plurality of craft is greater than a set distance.

3. The system of claim 2, wherein the third craft is the nearest craft, of the plurality of craft, to the second craft.

4. The system of claim 2, wherein the third craft is the most distant craft, of the plurality of craft, from the second craft.

5. The system of claim 1, wherein the first condition is satisfied when a separation between a second craft of the plurality of craft and a third craft of the plurality of craft is less than a set distance.

6. The system of claim 5, wherein the third craft is the nearest craft, of the plurality of craft, to the second craft.

7. The system of claim 1, wherein the execution of the regrouping maneuver further comprises the first craft moving to a position within a threshold distance of a set geographic location.

8. The system of claim 7, wherein the threshold distance is 3 meters.

9. The system of claim 1, wherein the execution of the regrouping maneuver further comprises the first craft moving to within a threshold distance of a set position relative to a center of the plurality of craft.

10. The system of claim 9, wherein the center of the plurality of craft is the centroid of the plurality of craft.

11. The system of claim 1, wherein the execution of the regrouping maneuver further comprises the first craft moving to within a threshold distance of a set position relative to a second craft of the plurality of craft.

12. The system of claim 11, wherein the execution of the regrouping maneuver further comprises the second craft remaining in the fluid-tracking state during the regrouping maneuver.

13. The system of claim 1, wherein the first condition is satisfied when the distance between the first craft and a center of the plurality of craft exceeds a threshold distance.

14. The system of claim 13, wherein the execution of the regrouping maneuver further comprises the first craft moving to a location nearer the center of the plurality of craft than the threshold distance.

15. The system of claim 1, wherein each of the plurality of craft comprises a processor and a radio connected to the processor, and the system further comprises a maneuver controller configured to:
receive position information from each of the plurality of craft;
assess whether the first condition has been satisfied; and
command each of the plurality of craft to execute the regrouping maneuver when the first condition is satisfied.

16. The system of claim 15, wherein the maneuver controller comprises:
a processor;
a display;
a user input device; and
a radio configured to exchange data with each of the plurality of craft.

17. A method for controlling a system for characterizing fluid flow, the system comprising a plurality of craft, the method comprising:
when a spatial arrangement of the craft satisfies a first condition, executing a regrouping maneuver comprising:
transitioning, by a first craft of the plurality of craft, from a fluid-tracking state to a fluid-transiting state;
moving, by the first craft, to a different position; and
transitioning, by the first craft, from the fluid-transiting state to the fluid-tracking state.

18. The method of claim 17, wherein the first condition is satisfied when a separation between a second craft of the plurality of craft and a third craft of the plurality of craft is greater than a set distance.

19. The method of claim 17, wherein the first condition is satisfied when a separation between a second craft of the plurality of craft and a third craft of the plurality of craft is less than a set distance.

20. The method of claim 17, wherein the regrouping maneuver further comprises moving, by the first craft, to within a threshold distance of a set geographic location.
